(19) United States
(12) Patent Application Publication
(10) Pub. No.: US 2022/0236736 A1
(43) Pub. Date: Jul. 28, 2022

(54) DECENTRALIZED TRAJECTORY PLANNING FOR MULTI-AGENT COORDINATION

(71) Applicant: Intel Corporation, Santa Clara, CA (US)

(72) Inventors: Rafael de la Guardia Gonzalez, Teuchitlan (MX); Leobardo Campos Macias, Guadalajara (MX); David Gomez Gutierrez, Tlaquepaque (MX); Anthony Kyung Guzman Leguel, Guadalajara (MX); Jose Ignacio Parra Vilchis, Guadalajara (MX)

(21) Appl. No.: 17/712,113

(22) Filed: Apr. 2, 2022

(51) Int. Cl. G05D 1/02

(52) U.S. Cl. CPC G05D 1/0214; G05D 1/0274; G05D 1/0289; G05D 1/0217

(57) ABSTRACT

Techniques are disclosed for a decentralized path and motion planning of autonomous agents within an environment. The planning may include determining if an active neighboring autonomous agent is present and selectively controlling the autonomous agent to operation in in an independent path planning operation mode and in a coordinating path planning operation mode, based on the detection of the neighboring agent(s).

### TECHNICAL FIELD

The disclosure generally relates to motion and path planning for autonomous systems, including decentralized motion and path planning for autonomous agents as well as the coordination between two or more autonomous agents.

### BACKGROUND

Path planning methods for autonomous agents, such as Autonomous Mobile Robots (AMRs), can be classified as either centralized or decentralized path planning methods. Centralized methods utilize a central controller with knowledge of the positions and target destinations of the AMRs within the environment. The central controller is responsible for generating a coordinated plan of trajectories for all the AMRs and for communicating the respective plan to each AMR. The AMRs then use their respective plan for its real-time on-board navigation control. Centralized methods may be difficult to scale and typically become computationally intensive.

Decentralized methods generate collision-free paths for individual robots and may use reactive collision avoidance. Reactive techniques are unreliable in cluttered, semi-structured environments. For example, decentralized methods may suffer from a lack completeness and optimality guarantees, require simplified environments, such as convexity of obstacles and invariance of the communication graph, do not provide global solution, may suffer from local minima and deadlocks, and may have high computational complexity.

### BRIEF DESCRIPTION OF THE DRAWINGS/FIGURES

The accompanying drawings, which are incorporated herein and form a part of the specification, illustrate the present disclosure and, together with the description, and further serve to explain the principles of the disclosure and to enable a person skilled in the pertinent art to make and use the techniques discussed herein.

FIG. 1A illustrates a block diagram of an exemplary decentralized environment utilizing autonomous mobile robots (AMRs), in accordance with the disclosure.

FIG. 1B illustrates a block diagram of an exemplary centralized environment utilizing AMRs, in accordance with the disclosure.

FIG. 2 illustrates a block diagram of an exemplary AMR in accordance with the disclosure.

FIG. 3 illustrates a block diagram of an exemplary computing device (controller) in accordance with the disclosure.

FIG. 4 illustrates an operational flowchart of planning method in accordance with the disclosure.

FIG. 5 illustrates an operational flow of a road map generation method in accordance with the disclosure.

FIGS. 6A-6E illustrate an operational flow of a trajectory generation method in accordance with the disclosure.

FIGS. 7A-7C illustrate an operational flow of a trajectory adjustment of interacting agents in accordance with the disclosure.

FIGS. 8A-8C illustrate comparison plots of simulated environments in accordance with the disclosure.

The present disclosure will be described with reference to the accompanying drawings. The drawing in which an element first appears is typically indicated by the leftmost digit(s) in the corresponding reference number.

### DETAILED DESCRIPTION

The following detailed description refers to the accompanying drawings that show, by way of illustration, exemplary details in which the disclosure may be practiced. In the following description, numerous specific details are set forth in order to provide a thorough understanding of the present disclosure. However, it will be apparent to those skilled in the art that the various designs, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring the disclosure.

The present disclosure provides an advantageous solution to decentralized motion and path planning for autonomous agents as well as the coordination between two or more autonomous agents, such as autonomous mobile robots (AMRs). The environment may be a partial or fully autonomous environment, or one that is generally free of autonomous agents (non-autonomous environments).

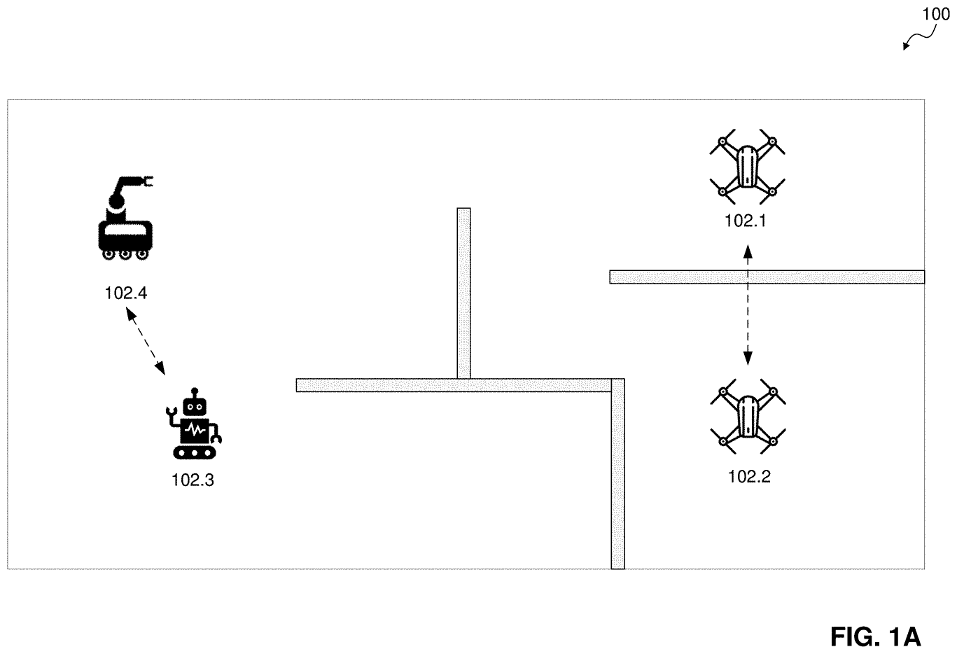

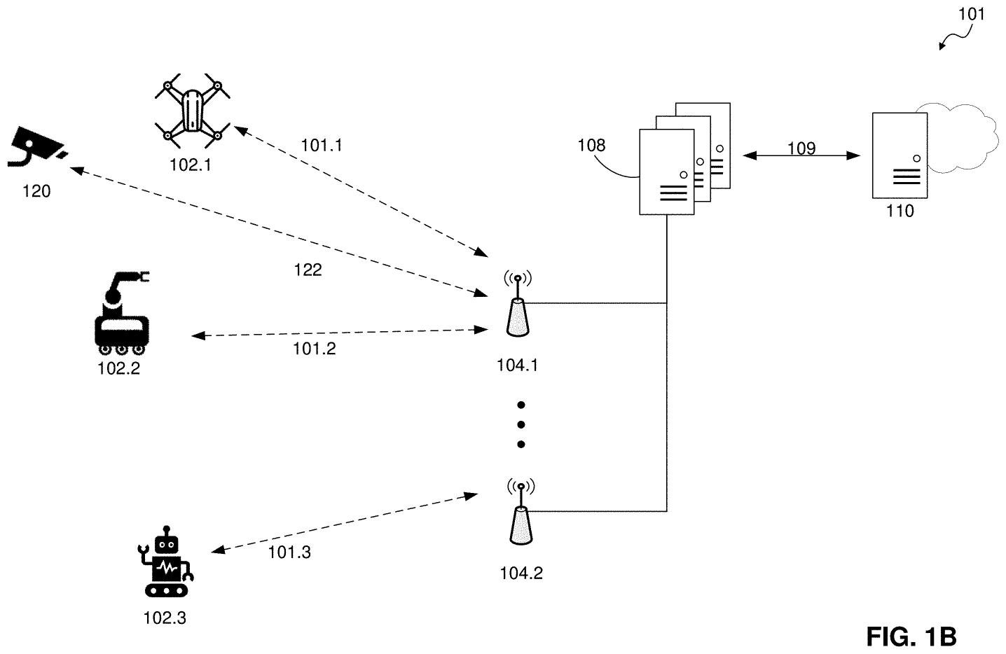

Autonomous agents, such as AMRs, are increasing being adapted for use in factories, warehouses, hospitals, and other industrial and/or commercial environments. Autonomous mobile platforms implement perception and manipulation jointly to accomplish a given task by navigating an environment. AMRs may communicate and coordinating with one other (FIG. 1A) and/or with a central controller (FIG. 1B) in centralized implementations. The motion and path planning of the present disclosure is described with respect to decentralized environments, but the aspects of the disclosure are also applicable to partial or fully centralized environments.

According to the disclosure, the system is configured to implement a decentralized algorithm that generates collision-free trajectories for multiple cooperating AMRs in a shared, dynamic environment. The method guarantees that collision-free trajectories are generated, considering the obstacles detected by the AMR's sensors and the neighboring AMR's sensors, and the trajectories of neighboring AMRs themselves. The systems and methods are advantageously fast and scalable and usable in cluttered, semi-structured environments, such as building interiors.

According to the disclosure, the algorithm may use a multi-stage approach, including:
1) an efficient, any-time stochastic plan for individual AMRs, using sub-goals to guide the search in two-dimensional (2D) and three-dimensional (3D) spaces;
2) an adaptation of the plan to account for intended sub-goals of neighboring AMRs within a planning radius, limiting the search to the composite roadmap from the AMRs and using the cost-to-go computed by each AMR in the first planning stage to guide the search towards a solution; and
3) generation of the roadmap solution for each AMR is used to create a trajectory that fulfills the dynamical constraints of the AMR and considers the surrounding AMRs' trajectories to ensure a collision-free trajectory.

FIG. 1A illustrates an exemplary decentralized environment 100. The environment 100 may utilize autonomous mobile robots (AMRs) 102 in accordance with the disclosure. The environment 100 supports any suitable number of AMRs 102, with four AMRs 102.1-102.4 being shown for ease of explanation.

The environment 100 may be any suitable type of environment that may use AMRs 102, such as a factory, warehouse, hospital, office building, etc. The AMRs 102 may have any suitable type of design and function to communicate with other components of a network infrastructure as further disused below. The AMRs 102 may operate autonomously or semi-autonomously and be configured as mobile robots that move within the environment 100 to complete specific tasks. One or more of the AMRs 102 may alternatively be configured as a stationary robot having moveable components (e.g. moveable arms) to complete localized tasks.

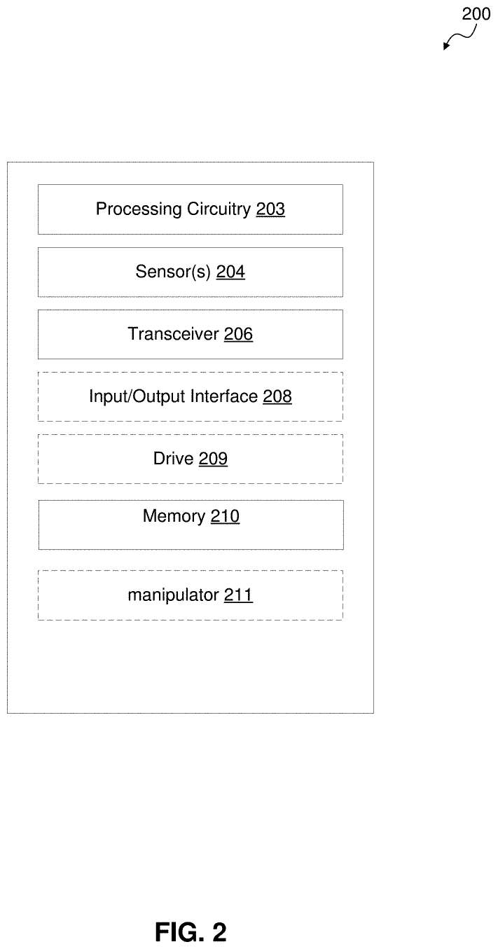

With reference to FIG. 2, the AMRs 102 may implement a suite of onboard sensors 204 to generate sensor data indicative of the location, position, velocity, heading orientation, etc. of the AMR 102. These sensors 204 may be implemented as any suitable number and/or type that are generally known and/or used for autonomous navigation and environmental monitoring. Examples of such sensors may include radar, LIDAR, optical sensors, cameras, compasses, gyroscopes, positioning systems for localization, accelerometers, etc. Thus, the sensor data may indicate the presence of and/or range to various objects near each AMR 102. Each AMR 102 may additionally process this sensor data to identify obstacles or other relevant information within the environment 100. The AMRs 102 may then use the sensor data to iteratively calculate respective navigation paths, as further discussed herein. The AMRs 102 may also any suitable number and/or type of hardware and software configuration to facilitate autonomous navigation functions within the environment 100, including known configurations. For example, each AMR 102 may implement a controller that may comprise one or more processors or processing circuitry 202, which may execute software that is installed on a local memory 210 to perform various autonomous navigation-related functions.

The AMR 102 may use onboard sensors 204 to perform pose estimation and/or to identify e.g. a position, orientation, velocity, direction, and/or location of the AMR 102 within the environment 100 as the AMR 102 moves along a particular planned path. The processing circuitry 202 can execute a path planning algorithm stored in memory 210 to execute path planning and sampling functionalities for navigation-related functions (e.g. SLAM, octomap generation, multi-robot path planning, etc.) of the AMR 102.

The AMRs 102 may further be configured with any suitable number and/or type of wireless radio components to facilitate the transmission and/or reception of data. For example, the AMRs 102 may transmit data (to other AMR(s)) indicative of current tasks being executed, one or more planned paths, roadmaps, location, orientation, velocity, trajectory, heading, etc. within the environment 100 (via transceiver 206 as shown in FIG. 2).

Although the disclosure includes examples of the environment 100 being a factory or warehouse supports AMRs 102 operating within such an environment, this is by way of example and not a limitation. The teachings of the disclosure may be implemented in accordance with any suitable type of environment and/or type of mobile agent. For instance, the environment 100 may be outdoors and be identified with a region such as a roadway that is utilized by autonomous vehicles. Thus, the teachings of the disclosure are applicable to AMRs as well as other types of autonomous agents that may operate in any suitable type of environment based upon any suitable application or desired function.

The AMRs 102 operate within the environment 100 by independent path planning and/or coordinating/cooperative path planning by communicating with one or more other AMRs 102. The AMRs 102 may include any suitable combination of wireless communication components that operate in accordance with any suitable number and/or type of wireless communication protocols. For instance, the network infrastructure may include optical links and/or wireless links such as Wi-Fi (e.g. Institute of Electrical and Electronics Engineers (IEEE) 802.11 Working Group Standards) and cellular links (e.g. 3GPP standard protocols, LTE, 5G, etc.). Communications between AMRs 102 may be directed to one or more individual AMRs and/or broadcast to multiple AMRs 102. Communications may be relayed by or more network components (e.g. access points) and/or via one or more other intermediate AMRs 102.

The AMRs 102 may be configured to process sensor data from one or more of its sensors and/or other information about the environment 100 that is already known, such as map data, which may include data regarding the size and location of static objects in the environment 100, last known locations of dynamic objects, etc. The processed data may be used to generate an environment model represented as a navigation grid having cells of any suitable size and/or shape, with each cell having specific properties with respect to the type of object contained (or not contained) in the cell, whether an object in the cell is static or moving, etc., which enables the environment model to accurately depict the nature of the environment 100. The respective environment model determined by the AMR 102 may be dynamically updated by the AMR 102 based on sensor or other data, and/or cooperatively based on data from one or more other AMRs 102.

Each AMR 102 may execute a path planning algorithm (exploration policy) to calculate its individual navigational path and/or a coordinated navigational path calculated at least in part using data from one or more other AMRs 102. The navigational paths include sets of intermediate points (“waypoints”) or nodes that define an AMR trajectory within the environment 100 between a starting point (e.g. its current location in the environment 100) to a destination (goal point) within the environment 100. That is, the waypoints indicate to the AMRs 102 how to execute a respective planned navigational path to proceed to each of the intermediate points at a specific time until a destination is reached. The path planning algorithm of one or more of the AMRs 102 may be irrelatively updated by the AMR 102. According to the disclosure, the AMR(s) 102 may implement machine-learning to adapt one or more algorithms and/or models configured to control the operation of the AMR 102 within the environment 100. One or more of the AMRs 102 may alternatively or additionally, in collaboration with one or more other AMRs 102, calculate navigational paths. The AMRs 102 may include processing circuitry that is configured to perform the respective functions of the AMR 102.

Information dynamically discovered by the AMRs 102 may be, for instance, a result of each AMR 102 locally processing its respective sensor data. Because of the dynamic nature of the environment 100, each AMR 102 may calculate its own respective navigation path in a continuous and iterative manner based on its sensor data, senor or other data from one or more other AMRs 102, map or other data as would be understood by one of ordinary skill in the arts.

Although aspects are described with respect to decentralized environments, the aspects of the disclosure may also be applied in partial or full centralized environments. An exemplary centralized environment 101 is illustrated in FIG. 1B. The environment 101 may utilize AMRs 102 in accordance with the disclosure. The environment 101 supports any suitable number of AMRs 102, with three AMRs 102.1-102.3 being shown for ease of explanation. The environment 101 may include one or more sensors 120 configured to monitor the locations and activities of the AMRs 102, humans, machines, other robots, or other objects (as would be understood by one of ordinary skill in the art) within the environment 101. The sensors 120 may include, for example, radar, LIDAR, optical sensors, infrared sensors, cameras, or other sensors as would be understood by one or ordinary skill in the art. The sensors may communicate information (sensor data) with the computing device 108 (via access point(s) 104). Although not shown in FIG. 1B for purposes of brevity, the sensor(s) 120 may additionally communicate with one another and/or with one or more of the AMRs 102.

The environment 101 may be any suitable type of environment that may use AMRs 102, such as a factory, warehouse, hospital, office building, etc. The AMRs 102 may have any suitable type of design and function to communicate with other components of a network infrastructure as further disused below. The AMRs 102 may operate autonomously or semi-autonomously and be configured as mobile robots that move within the environment 101 to complete specific tasks. One or more of the AMRs 102 may alternatively be configured as a stationary robot having moveable components (e.g. moveable arms) to complete localized tasks.

The AMRs 102 may include any suitable number and/or type of sensors to enable sensing of their surroundings and the identification of feedback regarding the environment 101. The AMRs 102 may further be configured with any suitable number and/or type of wireless radio components to facilitate the transmission and/or reception of data. For example, the AMRs 102 may transmit data indicative of current tasks being executed, location, orientation, velocity, trajectory, heading, etc. within the environment 101 (via transceiver 206 as shown in FIG. 2). As another example, the AMRs 102 may receive commands and/or planned path information from the computing device 108, which each AMR 102 may execute to navigate to a specific location within the environment 101. Although not shown in FIG. 1B for purposes of brevity, the AMRs 102 may additionally communicate with one another to determine information (e.g. current tasks being executed, location, orientation, velocity, trajectory, heading, etc.) with respect to the other AMRs 102, as well as other information such as sensor data generated by other AMRs 102.

The AMRs 102 operate within the environment 101 by communicating with the various components of the supporting network infrastructure. The network infrastructure may include any suitable number and/or type of components to support communications with the AMRs 102. For example, the network infrastructure may include any suitable combination of wired and/or wireless networking components that operate in accordance with any suitable number and/or type of communication protocols. For instance, the network infrastructure may include interconnections using wired links such as Ethernet or optical links, as well as wireless links such as Wi-Fi (e.g. 802.11 protocols) and cellular links (e.g. 3GPP standard protocols, LTE, 5G, etc.). The network infrastructure may be, for example, an access network, an edge network, a mobile edge computing (MEC) network, etc. In the example shown in FIG. 1, the network infrastructure includes one or more cloud servers 110 that enable a connection to the Internet, which may be implemented as any suitable number and/or type of cloud computing devices. The network infrastructure may additionally include a computing device 108, which may be implemented as any suitable number and/or type of computing device such as a server. The computing device 108 may be implemented as an Edge server and/or Edge computing device, but is not limited thereto. The computing device 108 and/or server 110 may also be referred to as a controller.

According to the disclosure, the computing device 108 may communicate with the one or more cloud servers 110 via one or more links 109, which may represent an aggregation of any suitable number and/or type of wired and/or wireless links as well as other network infrastructure components that are not shown in FIG. 1 for purposes of brevity. For instance, the link 109 may represent additional cellular network towers (e.g. one or more base stations, eNodeBs, relays, macrocells, femtocells, etc.). According to the disclosure, the network infrastructure may further include one or more access points (APs) 104. The APs 104 which may be implemented in accordance with any suitable number and/or type of AP configured to facilitate communications in accordance with any suitable type of communication protocols. The APs 104 may be configured to support communications in accordance with any suitable number and/or type of communication protocols, such as an Institute of Electrical and Electronics Engineers (IEEE) 802.11 Working Group Standards. Alternatively, the APs 104 may operate in accordance with other types of communication standards other than the 802.11 Working Group, such as cellular based standards (e.g. “private cellular networks) or other local wireless network systems, for instance. Additionally, or alternatively, the AMRs 102 may communicate directly with the computing device 108 or other suitable components of the network infrastructure without the need to use the APs 104. Additionally, or alternatively, one or more of AMRs 102 may communicate directly with one or more other AMRs 102.

In the environment 101 as shown in FIG. 1B, the computing device 108 is configured to communicate with one or more of the AMRs 102 to receive data from the AMRs 102 and to transmit data to the AMRs 102. This functionality may be additionally or alternatively be performed by other network infrastructure components that are capable of communicating directly or indirectly with the AMRs 102, such as the one or more cloud servers 110, for instance. However, the local nature of the computing device 108 may provide additional advantages in that the communication between the computing device 108 and the AMRs 102 may occur with reduced network latency. Thus, according to the disclosure, the computing device 108 is used as the primary example when describing this functionality, although it is understood that this is by way of example and not limitation. The one or more cloud servers 110 may function as a redundant system for the computing device 108.

The computing device 108 may thus receive sensor data from each for the AMRs 102 via the APs 104 and use the respective sensor data, together with other information about the environment 101 that is already known (e.g. data regarding the size and location of static objects in the environment 101, last known locations of dynamic objects, etc.), to generate a shared environment model that represents the environment 101. This shared environment model may be represented as a navigation grid having cells of any suitable size and/or shape, with each cell having specific properties with respect to the type of object contained (or not contained) in the cell, whether an object in the cell is static or moving, etc., which enables the environment model to accurately depict the nature of the environment 101. The environment model may thus be dynamically updated by the AMRs 102 directly and/or via the computing device 108 (e.g. by the policy learning engine 402) on a cell-by-cell basis as new sensor data is received from the AMRs 102 to generate an exploration policy for the AMRs 102. The updates to the shared environment model thus reflect any recent changes in the environment 101 such as the position and orientation of each of the AMRs 102 and other obstacles that may change in a dynamic manner within the environment 101 (e.g. people, forklifts, machinery, etc.). The shared environment model may additionally or alternatively be updated based upon data received from other sensors 120 or devices within the environment 101, such as stationary cameras for example, which may enable a more accurate depiction of the positions of the AMRs 102 without relying on AMR communications.

Each AMR 102 may execute a path planning algorithm (exploration policy) and uses the shared environment model at a particular time (e.g. the most recently constructed) to calculate navigational paths for each AMR 102. These navigational paths include sets of intermediate points (“waypoints”) or nodes that define an AMR trajectory within the environment 101 between a starting point (e.g. its current location in the environment 101) to a destination (goal point) within the environment 101. That is, the waypoints indicate to the AMRs 102 how to execute a respective planned navigational path to proceed to each of the intermediate points at a specific time until a destination is reached. The path planning algorithm of one or more of the AMRs 102 may be updated by the computing device 108 (e.g. by the policy learning engine 402). According to the disclosure, the computing device 108, server 110, and/or AMR(s) 102 may implement machine-learning to adapt one or more algorithms and/or models configured to control the operation of the AMRs 104 within the environment 101.

The computing device 108 may alternatively or additionally (potentially in collaboration with one or more of the AMRs 102) calculate navigational paths for one or more of the AMRs 102. Alternatively, or additionally, the cloud server(s) 110 may be configured to calculate navigational paths for one or more of the AMRs 102, which may then be transmitted to the AMRs 102. It should be appreciated that any combination of the AMRs 102, computing device 108, and cloud server(s) 110 may calculate the navigational paths. The AMRs 102, computing device 108, and/or cloud server(s) 110 may include processing circuitry that is configured to perform the respective functions of the AMRs 102, computing device 108, and/or cloud server(s) 110, respectively. One or more of these devices may further be implemented with machine-learning capabilities.

Information dynamically discovered by the AMRs 102 may be, for instance, a result of each AMR 102 locally processing its respective sensor data. The updated shared environment model may be maintained by computing device 108 (e.g. configured as a central controller) and shared with each of the AMRs 102 as well being used for planning tasks. Thus, at any given point in time, the AMRs 102 may be attempting to determine which cells to add to a particular route (e.g. a planned path) or move to so that the assigned tasks of the assigned tasks of the AMRs 102 may be accomplished in the most efficient manner. In other words, because of the dynamic nature of the environment 101, each AMR 102 may calculate its own respective navigation path in a continuous and iterative manner using iterative updates that are provided to the shared environment model. Thus, the shared environment model may be stored in the computing device 108 and/or locally in a memory associated with or otherwise accessed by each one of the AMRs 102. Additionally, or alternatively, the shared environment model may be stored in any other suitable components of the network infrastructure or devices connected thereto. In any event, the AMRs 102 may iteratively receive or otherwise access the shared environment model, including the most recent updates, to perform navigation path planning functions as discussed herein. The shared environment model may thus be updated as new sensor data is received by the central controller (computing device 108) and processed, and/or processed locally by the AMRs 102, and be performed in a periodic manner or in accordance with any suitable schedule.

With reference to FIG. 2, and as discussed above, the AMRs 102 may implement a suite of onboard sensors 204 to generate sensor data indicative of the location, position, velocity, heading orientation, etc. of the AMR 102. The sensor data may indicate the presence of and/or range to various objects near each AMR 102. Each AMR 102 may additionally process this sensor data to identify obstacles or other relevant information within the environment 100 that will impact the shared environment model. The AMRs 102 may then use the shared environment model to iteratively calculate respective navigation paths, as further discussed herein. The AMRs 102 may also any suitable number and/or type of hardware and software configuration to facilitate autonomous navigation functions within the environment 101.

### Computing Device (Controller) Design and Configuration

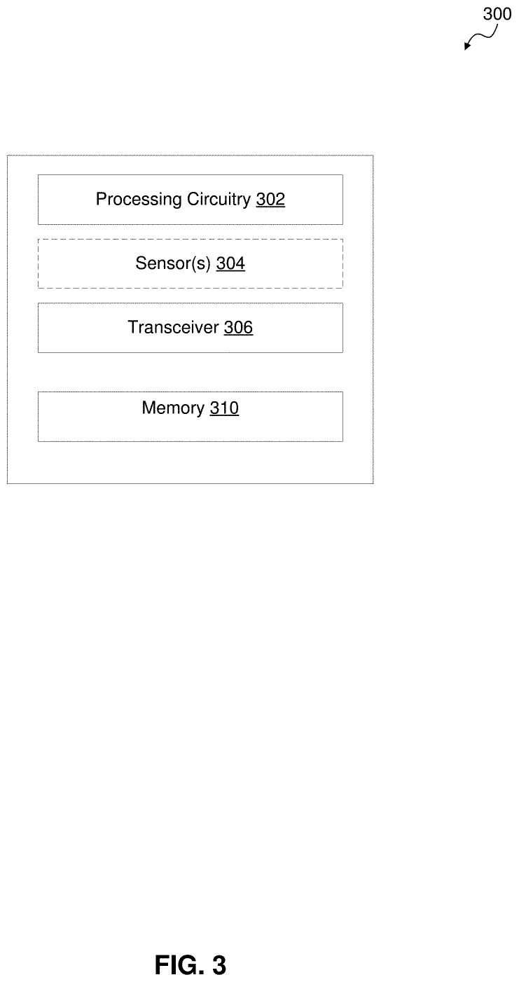

FIG. 3 illustrates a block diagram of an exemplary computing device 300, in accordance with the disclosure. The computing device (controller) 300 as shown and described with respect to FIG. 3 may be identified with the computing device 108 and/or server 110 as shown in FIG. 1B and discussed herein, for instance. The computing device 300 may be implemented as an Edge server and/or Edge computing device, such as when identified with the computing device 108 implemented as an Edge computing device and/or as a cloud-based computing device when identified with the server 110 implemented as a cloud server.

The computing device 300 may include processing circuitry 302, one or more sensors 304, a transceiver 306, and a memory 310. In some examples, the computer device 300 is configured to interact with one or more external sensors (e.g. sensor 120) as an alternative or in addition to including internal sensors 304. The components shown in FIG. 3 are provided for ease of explanation, and the computing device 300 may implement additional, less, or alternative components as those shown in FIG. 3.

The processing circuitry 302 may be configured as any suitable number and/or type of computer processors, which may function to control the computing device 300 and/or other components of the computing device 300. The processing circuitry 302 may be identified with one or more processors (or suitable portions thereof) implemented by the computing device 300.

The processing circuitry 302 may be configured to carry out instructions to perform arithmetical, logical, and/or input/output (I/O) operations, and/or to control the operation of one or more components of computing device 300 to perform various functions as described herein. For example, the processing circuitry 302 may include one or more microprocessor cores, memory registers, buffers, clocks, etc., and may generate electronic control signals associated with the components of the computing device 300 to control and/or modify the operation of these components. For example, the processing circuitry 302 may control functions associated with the sensors 304, the transceiver 306, and/or the memory 310.

According to the disclosure, the processing circuitry 302 may be configured to: determine and/or select the type of AMR 102 to be deployed within the environment 101; control (possibly in collaboration with the AMR(s) 102) the operation of the AMR(s) 102 within the environment 101, such as controlling the AMR(s) 102 to explore the environment 101; control the AMR(s) 102 to gather additional data or information about the environment 101; to gather information or data for a location within the environment 101 that may be insufficiently identified or known to the system (e.g. due to a lack of sensors 120 at the location); and/or one or more other functions as would be understood by one of ordinary skill in the art.

The sensors 304 may be implemented as any suitable number and/or type of sensors that may be used for autonomous navigation and environmental monitoring. Examples of such sensors may include radar, LIDAR, optical sensors, cameras, compasses, gyroscopes, positioning systems for localization, accelerometers, etc. In some examples, the computing device 300 is additionally or alternatively configured to communicate with one or more external sensors similar to sensors 304 (e.g. sensor 120 in FIG. 1).

The transceiver 306 may be implemented as any suitable number and/or type of components configured to transmit and/or receive data packets and/or wireless signals in accordance with any suitable number and/or type of communication protocols. The transceiver 306 may include any suitable type of components to facilitate this functionality, including components associated with known transceiver, transmitter, and/or receiver operation, configurations, and implementations. Although depicted in FIG. 3 as a transceiver, the transceiver 306 may include any suitable number of transmitters, receivers, or combinations of these that may be integrated into a single transceiver or as multiple transceivers or transceiver modules. For example, the transceiver 306 may include components typically identified with an RF front end and include, for example, antennas, ports, power amplifiers (PAs), RF filters, mixers, local oscillators (LOs), low noise amplifiers (LNAs), upconverters, downconverters, channel tuners, etc. The transceiver 306 may also include analog-to-digital converters (ADCs), digital to analog converters, intermediate frequency (IF) amplifiers and/or filters, modulators, demodulators, baseband processors, and/or other communication circuitry as would be understood by one of ordinary skill in the art.

The memory 310 stores data and/or instructions such that, when the instructions are executed by the processing circuitry 302, cause the computing device 300 to perform various functions as described herein. The memory 310 may be implemented as any well-known volatile and/or non-volatile memory. The memory 310 may be implemented as a non-transitory computer readable medium storing one or more executable instructions such as, for example, logic, algorithms, code, etc. The instructions, logic, code, etc., stored in the memory 310 are may be represented by various modules which may enable the features described herein to be functionally realized. For example, the memory 310 may include one or more modules representing an algorithm, such a path planning module configured to perform the path planning operations. For hardware implementations, the modules associated with the memory 310 may include instructions and/or code to facilitate control and/or monitor the operation of such hardware components. Thus, the disclosure includes the processing circuitry 302 executing the instructions stored in the memory in conjunction with one or more hardware components to perform the various functions described herein.

### AMR Design and Configuration

Turning back to FIG. 2, a block diagram of an exemplary autonomous agent 200 in accordance with the disclosure is illustrated. The autonomous agent 200 as shown and described with respect to FIG. 2 may be identified with one or more of the AMRs 102 as shown in FIGS. 1A-1B and discussed herein. The autonomous agent 200 may include processing circuitry 202, one or more sensors 204, a transceiver 206, and a memory 210. The autonomous agent 200 may additionally include input/output (I/O) interface 208, drive 209 (e.g. when the agent 200 is a mobile agent), and/or manipulator 211. The components shown in FIG. 2 are provided for ease of explanation, and the autonomous agent 200 may implement additional, less, or alternative components as those shown in FIG. 2.

The processing circuitry 202 may be configured as any suitable number and/or type of computer processors, which may function to control the autonomous agent 200 and/or other components of the autonomous agent 200. The processing circuitry 202 may be identified with one or more processors (or suitable portions thereof) implemented by the autonomous agent 200. The processing circuitry 202 may be configured to carry out instructions to perform arithmetical, logical, and/or input/output (I/O) operations, and/or to control the operation of one or more components of autonomous agent 200 to perform various functions associated with the disclosure as described herein. For example, the processing circuitry 202 may include one or more microprocessor cores, memory registers, buffers, clocks, etc., and may generate electronic control signals associated with the components of the autonomous agent 200 to control and/or modify the operation of these components. For example, the processing circuitry 202 may control functions associated with the sensors 204, the transceiver 206, interface 208, drive 209, memory 210, and/or manipulator 211. The processing circuitry 202 may additionally perform various operations to control the movement, speed, and/or tasks executed by the autonomous agent 200, which may be based upon global and/or local path planning algorithms, as discussed herein.

The sensors 204 may be implemented as any suitable number and/or type of sensors that may be used for autonomous navigation and environmental monitoring. Examples of such sensors may include radar, LIDAR, optical sensors, cameras, compasses, gyroscopes, positioning systems for localization, accelerometers, etc.

The transceiver 206 may be implemented as any suitable number and/or type of components configured to transmit and/or receive data packets and/or wireless signals in accordance with any suitable number and/or type of communication protocols. The transceiver 206 may include any suitable type of components to facilitate this functionality, including components associated with known transceiver, transmitter, and/or receiver operation, configurations, and implementations. Although depicted in FIG. 2 as a transceiver, the transceiver 206 may include any suitable number of transmitters, receivers, or combinations of these that may be integrated into a single transceiver or as multiple transceivers or transceiver modules. For example, the transceiver 206 may include components typically identified with an RF front end and include, for example, antennas, ports, power amplifiers (PAs), RF filters, mixers, local oscillators (LOs), low noise amplifiers (LNAs), upconverters, downconverters, channel tuners, etc. The transceiver 206 may also include analog-to-digital converters (ADCs), digital to analog converters, intermediate frequency (IF) amplifiers and/or filters, modulators, demodulators, baseband processors, and/or other communication circuitry as would be understood by one of ordinary skill in the art.

I/O interface 208 may be implemented as any suitable number and/or type of components configured to communicate with the human(s) 115. The I/O interface 208 may include microphone(s), speaker(s), display(s), image projector(s), light(s), laser(s), and/or other interfaces as would be understood by one of ordinary skill in the arts.

The drive 209 may be implemented as any suitable number and/or type of components configured to drive the autonomous agent 200, such as a motor or other driving mechanism. The processing circuitry 202 may be configured to control the drive 209 to move the autonomous agent 200 in a desired direction and at a desired velocity.

The memory 210 stores data and/or instructions such that, when the instructions are executed by the processing circuitry 202, cause the autonomous agent 200 to perform various functions as described herein. The memory 210 may be implemented as any well-known volatile and/or non-volatile memory. The memory 210 may be implemented as a non-transitory computer readable medium storing one or more executable instructions such as, for example, logic, algorithms, code, etc. The instructions, logic, code, etc., stored in the memory 210 may enable the features disclosed herein to be functionally realized. For hardware implementations, the modules shown in FIG. 2 associated with the memory 210 may include instructions and/or code to facilitate control and/or monitor the operation of such hardware components.

The manipulator 211 may be implemented as any suitable number and/or type of components configured to interact with and/or manipulate the environment and/or object(s) within the environment, such as a manipulator arm or other mechanism to interact with one or more objects.

### Motion Planning Algorithm

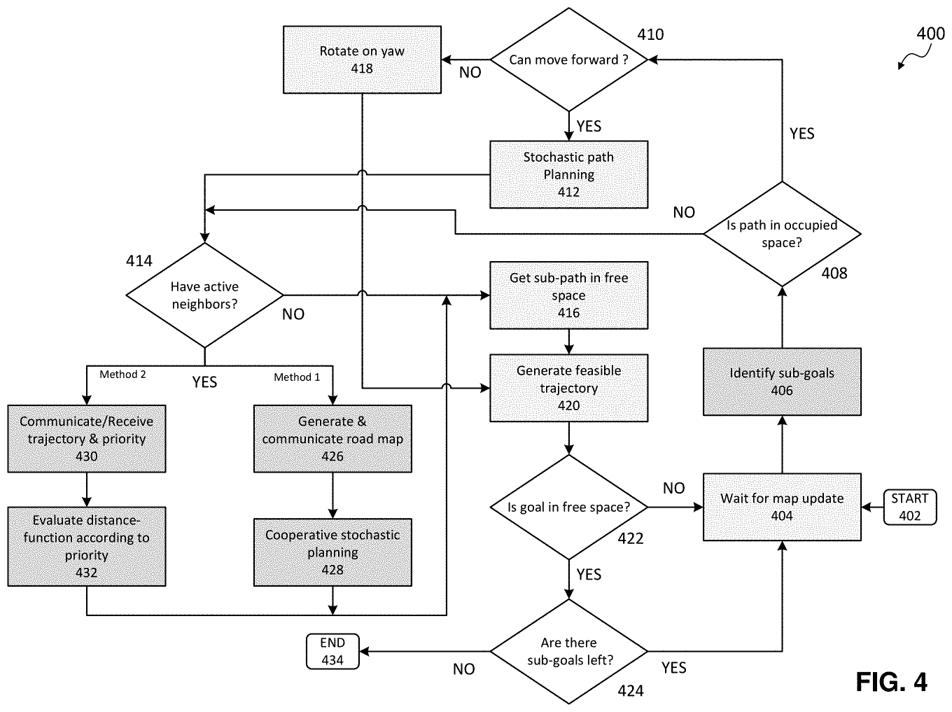

FIG. 4 illustrates a flowchart of an exemplary motion planning method 400 in accordance with the disclosure. The method 400 shown may be performed by each AMR 102, and the method may be iteratively performed until the goal is met or each identified sub-goal is completed. Two or more of the various operations illustrated in FIG. 4 may be performed simultaneously in some configurations. Further, the order of the various operations is not limiting and the operations may be performed in a different order in some configurations.

The planning algorithm according to the disclosure advantageously integrates both multi-robot path planning and autonomous navigation of a single robot in cluttered environments. In both the single robot and multi-robot cases, the planning solution includes a path connecting the current position of the AMR 102 with its final goal. According to the disclosure, the path is guaranteed to have its initial portion within the current field of view (FOV) of the AMR 102. This advantageously enables the AMR 102 to safely navigate in unknown or uncertain environments. Although the planning algorithms is described for AMRs 102 in the form of multi-copter drones, the disclosure is not limited thereto and the planning algorithms may be applied to other agents or vehicles as would be understood by one of ordinary skill in the art.

The flowchart 400 begins at 402 and transitions to operation 404, where the AMR 102 waits for a map update. The map may be updated based on sensor and/or other data obtained by the AMR 102 of the environment 100 and/or from sensor and/or other data obtained by one or more other AMRs 102 and provided to the AMR 102. At the initial performance of the method, the map may be update based on the initial FOV of the of the AMR 102 (e.g. what the sensors of the AMR 102 can initially detect).

After operation 404, the flowchart transitions to operation 406, where sub-goals are identified. At an initial performance of the method, the identified sub-goal can set the sub-goal as a waypoint within the FOV of the AMR 102. Another example of a sub-goal could be to explore an unexplored area of the environment 100, to locate a person and/or object within the environment 100, or the like.

According to the disclosure, a path is a sequence of waypoints (i.e., states) through the search space of the AMR 102 that can be described by a continuous function of finite length. A roadmap is a collection of paths starting at the same point. The path planning algorithm ensures that each path includes at least one waypoint within the current FOV of the AMR 102. A plan is a connected path in the roadmap.

After operation 406, the flowchart transitions to operation 408, where the AMR 102 determines if a selected path is in occupied space. For example, the AMR 102 may check whether the FOV of the AMR 102 is occupied, such as by an object, person, wall, or the like. The determination of whether the pay is in occupied space may be based on sensor data from one or more sensors of the AMR 102. If the path is in occupied space, the flowchart transitions to operation 410, where the AMR 102 determines if the AMR 102 is able to move forward. If no, the flowchart transitions to operation 418, where the AMR 102 rotates on yaw (e.g. turns around) and then the flowchart transitions to operation 420. If the AMR 102 is able to move forward, the flowchart transitions to operation 412, where the AMR 102 performs stochastic path planning to generate a path with at least one waypoint. According to the disclosure, the path planning can be based on a Rapidly-exploring random tree (RRT) algorithm, an RRT* algorithm, Discrete rapidly-exploring random trees (DRRT) algorithm, DRRT* algorithm, or other algorithm as would be understood by one of ordinary skill in the art. According to the disclosure, the stochastic path planning may be based on the map data (from operation 404).

Prior to determining a sub-path in free space (e.g. within the FOV) at operation 416, the method includes determining if one or more other AMRs 102 are within the vicinity of the AMR 102 (e.g. within a communication radius of the AMR 102. If there are no neighboring AMRs 102, the flowchart transitions to operation 416, where the sub-path within the FOV is determined. In operation 416, a sub-path including at least one waypoint within the FOV is determined.

The flowchart then transitions to operation 420, where a trajectory is generated. According to the disclosure, the determined trajectory is feasible in that it considers the specifications (e.g. the maximum velocity) of the AMR 102. That is, the determined trajectory is one that fulfills the dynamic constraints of the AMR 102.

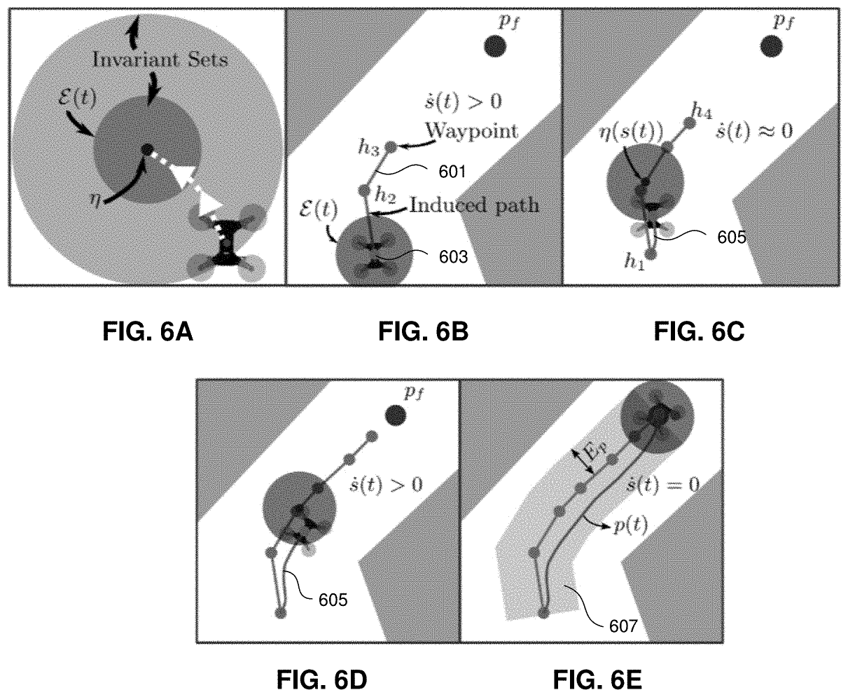

According to the disclosure, the trajectory is generated based on the following translational model, which is discussed with reference to FIGS. 6A-6E. For the ease of explanation, the translation model applied to a quadcopter autonomous agent, but the model is not limited thereto and can be applied to any agent type. The model is set forth in the following equations:

x(t)=[p(t),v(t), a(t), s(t)],

\dot{p}(t)=v(t)

\dot{v}(t)=a(t)

\dot{a}(t)=s(t)

\dot{s}(t)=j(t)

where, x(t) represents the state space and p(t), v(t), a(t), s(t), j(t) represent the position, velocity, acceleration, snap, and jerk, respectively. Jerk also acts as the control input.

According to the disclosure, the method induces an invariant set ε(t) that is stable at the origin. Then, the equilibrium point (the origin) is moved along the path, ensuring that all the states of the system remain inside the set. The process is repeated continuously until the sub-goal or the last waypoint in the roadmap is reached.

Turning to FIGS. 6A-6E, an example application is illustrated in a 2D representation. In FIG. 6A, the AMR 102 is inside an invariant set and is attracted towards the equilibrium point. In FIG. 6B, the line 601 (red) is the path induced by the first three waypoints. The current (green) point 603 is the position of the AMR 102 at the current time. Initially, the equilibrium point x* is selected as x*=[η, 0, . . . , 0], where η corresponds to the first waypoint. η is parametrized with a continuous, positive, and non-decreasing function s(t) to control the progress of the equilibrium point along the path. FIGS. 6C-6D show the trajectory 605 (green) traced by the AMR 102 as it follows η(s(t)). The condition \dot{s}(t)≥0 implies the equilibrium is moving forward along the path while the inventive method ensures the trajectory is in the interior of the invariant set. The trajectory 605 of the AMR 102 will remain inside the (pink) region 607 (defined by Eₚ) and will eventually reach the final position p_{ƒ} corresponding to the final waypoint as shown in FIG. 6E.

After the trajectory is determined, the AMR 102 determined if the goal is within the free space (e.g. FOV of the AMR 102) at operation 422. If so, the AMR 102 then determines if there are any additional sub-goals at operation 424. If so, the flowchart returns to operation 404, where the map is updated based on additional data obtained by the AMR 102 during its movements within the environment 100. If there are sub-goals remaining, the flowchart transitions to operation 434, where the flowchart ends.

Returning to the determination of whether one or more other AMRs 102 are within the vicinity of the AMR 102 at operation 414, if this determination returns in the affirmative, the flowchart transitions to either: operation 426 and then operation 428, or to operation 430 and then operation 432. Operations 426 and 428 may be referred to as cooperative stochastic planning method, while operations 430 and 432 may be referred to as a priority-based planning method. Following operations 428 and 432, the flowchart transitions to operation 416, where the sub-path within the FOV is determined. Although FIG. 4 is described with the priority-based planning method and the cooperative stochastic planning method being alternatives, according to the disclosure, the planning method 400 may implement both the priority-based planning method and the cooperative stochastic planning method within an iteration of the method 400.

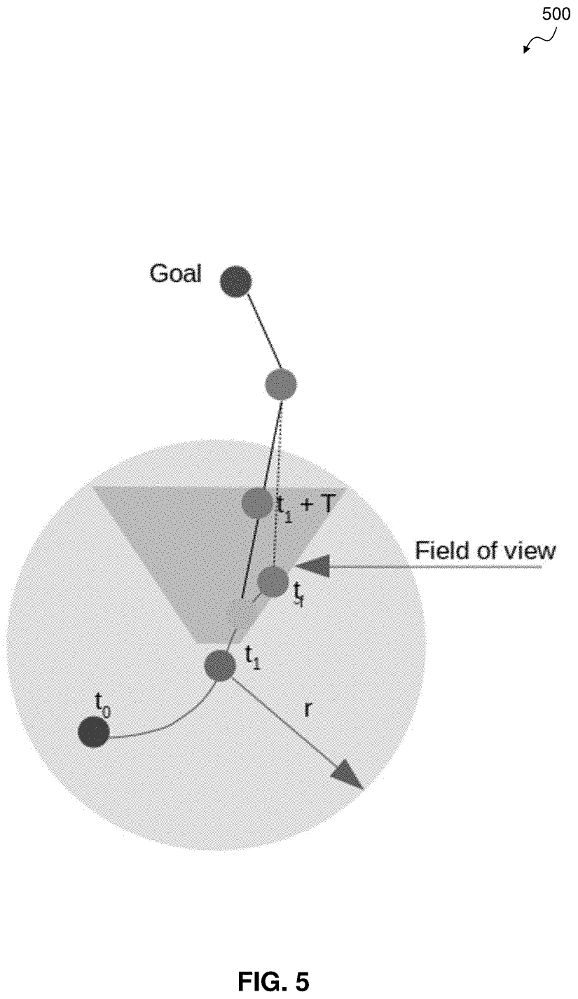

The cooperative stochastic planning method and the priority-based planning method are described in more detail with reference to FIGS. 5-8

### Decentralized Motion Planning

With the path generated from the stochastic path planning of operation 414, the AMR 102 selects an initial waypoint to travel to that is within its FOV. As shown in FIG. 5, from an initial position at time t₀, the AMR 102 finds and commits to reaching a position at time t_{f}=t₀+T, following a polynomial, minimum energy trajectory, which ends at the desired position with all derivatives equal to 0. To improve safety, the AMR 102 ensures that this position is with the FOV of the AMR 102. This desired position becomes the first waypoint for path planning.

According to the disclosure, the planning also may consider planned trajectories of the other neighboring AMRs 102. In particular, the desired position also avoids conflict with known planned trajectories from the other AMRs 102 as well as being within the FOV of the AMR 102. This is accomplished by the AMRs 102 sharing their planned paths, as well as relying on the constraint that the initial waypoint selected by the respective AMRs 102 is within their FOV.

When the AMR 102 re-plans at time t₁, it forecasts a future position along the current trajectory which is reachable from its current FOV. The forecasted position replaces the next waypoint, so the AMR 102 can continue without stopping along the planned path. Additionally, or alternatively, to improve safety, the communication radius of the AMR 102 (and other AMRs 102) may be set to at least 2 r, where r is the safety radius of the AMR 102. The safety radius r may be determined by the range of the sensor(s) of the AMR 102, which also delimits the FOV of the AMR 102. If the AMR 102 is unable to determine a new waypoint after it attempts to re-plan, the AMR 102 can continue to follow the current trajectory, which will bring it safely to a stop. Afterwards, the AMR 102 may attempt to re-plan again until it finds a solution.

According to the disclosure, the AMR 102 may deconflict its current plan (from operation 412) using, for example, the Discrete rapidly-exploring random trees (DRRT*) algorithm. Other algorithms may be used as understood by one of ordinary skill in the art. As discussed above, during path planning, the AMR 102 and each of the neighboring AMRs 102 commits to an initial waypoint in its FOV, which is known to be in unoccupied space and far from other AMRs 102 at planning time. The AMR 102 may then communicate (e.g. broadcast) the initial portion of its plan in the form of a roadmap to one or more other AMRs 102, as well as receives the roadmaps of the other AMRs 102 (operation 426 in FIG. 4). Unless a potential collision or conflict is detected, this will continue for a planning period T while the agent approaches its next waypoint. According to the disclosure, the planning period T is a predetermined period of time. In operation, the DRRT* algorithm seeks to optimize the distance travelled by the AMRs 102 in each time frame by searching in the composite configuration space of the tensor product roadmap of the AMRs 102. The algorithm is asymptotically optimal and computationally efficient. Advantageously, the path planning according to the disclosure adapts the centralized DRRT* algorithm for decentralized planning. For example, the AMRs 102 may implement the DRRT* algorithm to verifying that the paths of all the AMRs 102 are safe. According to the disclosure, the planning may insert repeated waypoints to force an AMR 102 to stop so that another AMR 102 can proceed along a contested road link, but without re-routing or changing the waypoints. In this example, if there is a head-on collision between two AMRs 102, the algorithm may force both agents to stay at their initial waypoints.

According to the disclosure, the AMR 102 may then perform waypoint following. In operation, the first waypoint in a new plan is selected such that the waypoint is within the FOV of the AMR 102 at the time of planning. As illustrated in FIG. 5, as the AMR 102 moves towards the next waypoint in its plan, this is no longer guaranteed, and the AMR 102 selects a new waypoint that will allow it to continue following the planned path. For example, assuming p_{i} is the next waypoint and E_{i,i+1} is the edge connecting waypoints p_{i} and p_{i+1}, path following determines the point p nearest to p_{i+1}, such that the distance between p and E_{i,i+1} is less than epsilon, for a suitable value of epsilon.

If the AMR 102 is unable to commit to an initial waypoint in its FOV with planning period T or is unable to perform waypoint following, or if the environment has changed, the AMR 102 generates a new path. According to the disclosure, the AMR 102 may use, for example, a an adapted RRT-Connect algorithm. The conventional RRT-Connect algorithm simultaneously expands two trees, one rooted at the start position while the other one is rooted at the final goal. The RRT-Connect algorithm alternates between extending each tree by adding a new node and attempting to connect the trees. According to the disclosure, the RRT-Connect algorithm is modified with respect to the initialization of the trees. For example, for the start tree, up to N_{f} points may be sampled in the current field of view prior to running RRT. These points are guaranteed to be reachable from the current position, which provides that the points are: 1) inside the FOV; 2) collision-free with respect to both static and dynamic obstacles, and 3) reachable in exactly time T, arriving with 0 velocity and acceleration. At initialization time of RRT, all these points are connected directly to the start node.

Pseudo-code for the FOV sampling algorithm according to the disclosure is provided below, with the inputs being safe_radius, and rays, and outputs being point:

1) point ← SampleRays(rays)
2) point ← Transform(point, cameraToWorld)
3) If (IsPointCollisionFree(point, safe_radius))
4) Return point
5) Else
6) point ← InvalidPoint
7) Return point

In the above algorithm, the input variable rays is an array of the rays traced from the focal point of the camera during the last sensor scan. These can be computed efficiently using a conventional space carving algorithm, such as the algorithm described in “Autonomous Navigation of MAVs in Unknown Cluttered Environments” by Leobardo Campos-Mac\acute{ }ₗas, et. al. The safe_radius corresponds to the safety radius r of the AMR, which may be determined by the range of the sensor(s) of the AMR 102.

In line 1 the rays are sampled to obtain a point in the free space inside the camera field of view. In line 2, the point is transformed from the camera frame to the world frame. The function IsPointCollisionFree in line 3, generates a trajectory from the current robot position to the obtained point, using the predefined-time trajectory generation algorithm described below; it then tests the trajectory for collisions with obstacles based on the current state of the map. If there are no collisions, the point is returned in line 4. Otherwise, the InvalidPoint is returned.

According to the disclosure, during execution of RRT, new points can be added to the start tree by connecting them to any of the initial FOV points, but not directly to the start node. This ensures that the first waypoint of any solution returned by RRT is a reachable point, as described above. The goal tree is initialized by sampling multiple points in the goal region. This allows multiple AMRs 102 to simultaneously plan trajectories to the same goal. Given a time budget, the RRT-Connect algorithm is run multiple times, using informed sampling to refine the solution. The AMR 102 then runs DRRT* on the composite roadmap formed by combining the roadmaps received from neighboring agents with the roadmap formed with the solutions found by RRT-Connect. This allows the AMR 102 to find global solutions which avoid congested areas, but which can take advantage of cooperation from other AMRs 102 when it is advantageous to do so. A reference point is then generated to move the AMR 102 along its path.

According to the disclosure, to implement DRRT* in a decentralized fashion, neighboring AMRs 102 can share a common reference system for collision checking. The sharing of a common reference system can use any conventional techniques as would be understood by one of ordinary skill in the art, such as the techniques described in U.S. Pat. No. 11,004,332.

In the conventional DRRT* algorithm, the START (resp. Goal) position corresponds to the initial (resp. Target) configuration of all the robots. According to the disclosure, the delay in communication is considered as the AMRs 102 are moving while planning. Therefore, according to the disclosure, the START configuration is set as the first waypoint from each AMR 102, which is computed in a decentralized way, considering the FOV and dynamic constraints. Advantageously, Collision checking is efficiently implemented in DRRT* by computing the nearest distance from sample points to the centerline of the tube connecting each pair of waypoints.

In the DRRT* algorithm, each AMR 102 has a single Goal and the planner minimizes the total distance from the START to the Goal configuration. According to the disclosure, each AMR 102 has multiple Goals. For example, in a two-robot scenario, a valid solution would be for one robot to remain at the START position while the other one moves to one of its sub-goals. The optimal solution is one that maximizes the total distance travelled by all the robots. The local roadmaps shared by the robots abstract away the map information available to each robot, so maps need not be identical. Robots can travel at different speeds while the trajectory generation scheme according to the disclosure ensures that the AMRs 102 are able to stop completely at any waypoint in their respective roadmaps. The implicit representation used by DRRT* is guaranteed to contain the optimal path for a set of AMRs moving simultaneously, and that the algorithm will asymptotically converge towards the optimal solution. This means that AMRs 102 working on the same roadmap would arrive at the same solution eventually. If they don't, given the limited computation time, the feasible trajectory generation method ensures that robots still move without collisions, even assuming that the robots are not visible to each other. The trajectory generation method guarantees that the maximum tracking error is within a predefined bound, which is also considered in our implementation of DRRT*. This will invalidate simultaneous path traversals that violate a minimum safe separation and force the AMRs 102 to re-plan.

According to the disclosure, the method employs a cost function in which the aggregate distance travelled by all the AMRs 102 is maximized. The size of the search space may be constrained by limiting the roadmaps to the planning region. Moreover, when a successful solution is found, AMRs 102 keep reusing it until they reach the next sub-goal unless the plan becomes invalid, either because of new obstacles detected in the field of view of the robot, or because of conflicting trajectories with other AMRs 102.

Turning back to FIGS. 6A-6E, once a solution is determined, a set of waypoints are used to construct a trajectory that fulfills the dynamic constraints of the AMR 102. According to the disclosure, the trajectory algorithm is adapted to account for the presence of neighboring AMRs 102. For example, the trajectory may be slowed down, if necessary to avoid collisions.

According to the disclosure, the generation of the of the trajectory (operation 420) by the AMR 102 considers the trajectory of one or more neighboring AMRs 102 through the implementation of the priority-based planning method (operations 430 and 432) or the cooperative stochastic planning method (operations 426 and 428). Although FIG. 4 is described with the priority-based planning method and the cooperative stochastic planning method being alternatives, the planning method 400 may implement both the priority-based planning method and the cooperative stochastic planning method in an iteration of the method 400.

### Priority-Based Planning

With reference to FIG. 4 and the operations 430 and 432 of the priority-based planning method, trajectory generation may be based on the position of other AMRs 102 with respect to the AMR 102. According to the disclosure, the velocity of the path traversal of the invariant set (e.g. the speed at which the dynamic system of the robot is contouring the path corresponding to the roadmap) may be decreased to avoid collisions. According to the disclosure, the speed of the AMR 102 may be set so as to be directly proportional to the relative distance to neighboring AMRs 102, considering their positions at each time step. That is, the closer the AMR 102 is to one or more other AMRs 102, the slower the path traversal will be for the AMR 102, until it stops completely considering the constraint \dot{s}(t)≥0. Additionally, or alternatively, the adjustment of the velocity of the AMR 102 may be based on a priority value associated with the AMR 102. In this example, the AMR 102 with the lower priority value will adjust (e.g. reduce) its velocity. The priority value may be determined based one or more factors, such as, the AMR with the shortest distance to its goal has a higher priority, the AMR with the longest distance has the higher priority, the AMR with the current higher velocity has the higher priority, a random determination, and/or one or more other factors as would be understood by one of ordinary skill in the art. The trajectory and/or priority information may be shared by the AMRs 102 when they come within communication range of one another.

According to the disclosure, the trajectory generation may be based on a distance-dependent function τ(p(t),pⁱ(t))→[0,1]. This results in an imposed dynamic for \dot{s}:

\dot{s}(t)=δτ

where δ is the maximum boundary for \dot{s} calculated, τ implies that the stability conditions are still fulfilled, and the method generates a trajectory with dynamic restrictions compliance, and 0≤\dot{s}(t)≤δ.

According to the disclosure, a selection for τ may be a function such that, as the Euclidean distance between AMRs 102 decreases, the evaluation of τ tends to zero. On the other hand, as the distance increases, τ goes to one. Furthermore, when the relative distance between the AMRs 102 is equal to the collision radius R_{c}, τ is zero. A corresponding function according to the disclosure is provided below:

$$τ ( p ( t ) , {p}^{i} ( t ) ) = \{ \begin{matrix}0.0 & {d}_{rel} \leq 2 {R}_{c} \\ min ( 1.0 , {γ ( {d}_{rel} - {R}_{c} )}^{2} ) & otherwise\end{matrix}$$

where dᵣₑₗ is the relative distance between the agents and γ is a positive hyperparameter to decide the vanishing effect of τ.

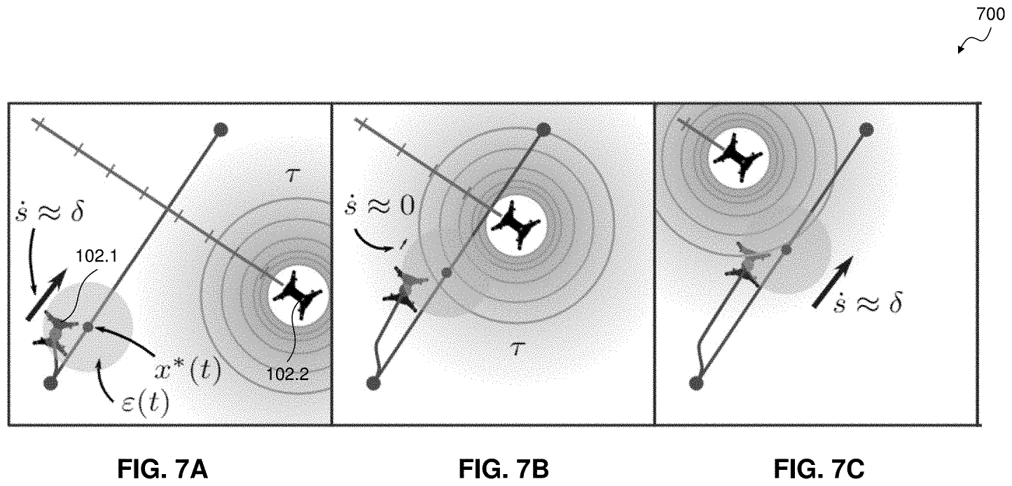

According to the disclosure, when the relative distance between the AMRs 102 decreases, since τ multiplies \dot{s}, the speed with which the equilibrium state x*(t) moves along the line segment is reduced, implying that the AMR 102 reduces its velocity. This is illustrated in FIGS. 7A-7C, which shows a sequence for two AMRs 102. In FIG. 7A, the AMR 102.1 moves at full speed since the relative distance with respect to AMR 102.2 is large. In FIG. 7B, the relative distance decreases, which causes τ→0, thereby stopping AMR 102.1 and allowing the neighboring AMR 102.2 to pass. In FIG. 7C, the relative distance increases as the AMR 102.2 passes AMR 102.1, thereby causing τ→1. This allows for AMR 102.1 to increase its velocity and continue in the roadmap. According to the disclosure, the trajectory determination may be performed at the planning stage, so that if a collision cannot be avoided even if the AMR 102 stops, the plan is rejected and new roadmaps are generated.

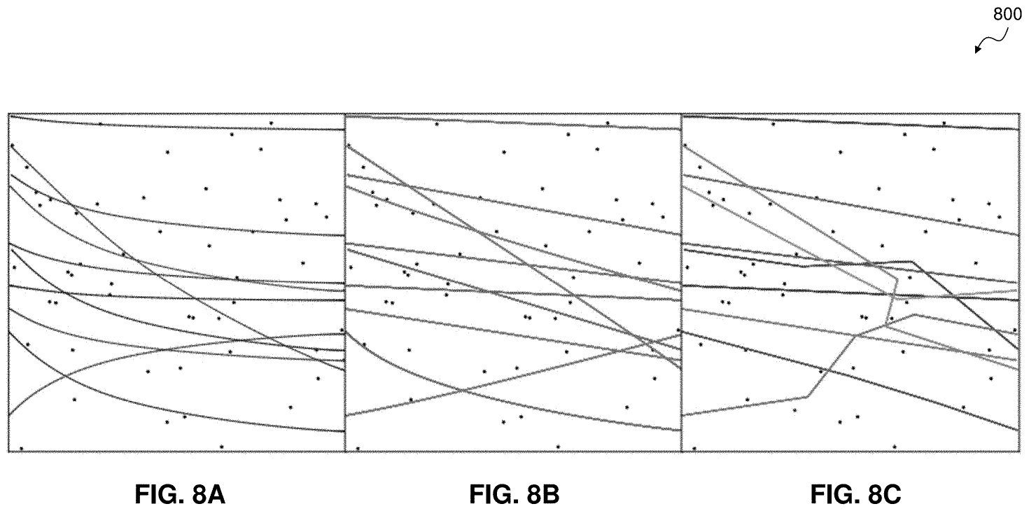

Simulation results of the priority-based planning method are illustrated in FIG. 8A-8C, with reference to Table 1 below. FIG. 8A illustrates a simulated forest environment with the traversed paths for ten agents, the gradients in the colors representing a different agent, for a distributed model predictive technique (C1). FIG. 8B illustrates a simulated forest environment with the traversed paths for ten agents, the gradients in the colors representing a different agent, for an incremental sequential convex programming technique (C2). FIG. 8C illustrates a simulated forest environment with the traversed paths for ten agents, the gradients in the colors representing a different agent, of the method according to the disclosure.

The corresponding results are illustrated below in Table 1.

TABLE 1
Comparison of distributed model predictive (C1) and incremental sequential
convex programming (C2) with the inventive method of the disclosure (D).

| | | Success | | | Avg. Path | | | Avg. Max | | |
|---|---|---|---|---|---|---|---|---|---|---|
| | | Rate[%] | | | Lenght [m] | | | Arrival Time [s] | | |
| Agents | Trees | C1 | C2 | D | C1 | C2 | D | C1 | C2 | D |
| 5 | 0 | 88 | 68 | 100 | 106.24 | 104.11 | 105.59 | 37.62 | 37.51 | 308.47 |
| | 25 | 84 | 64 | 100 | 107.95 | 105.84 | 109.73 | 43.00 | 42.87 | 321.97 |
| | 50 | 72 | 40 | 100 | 106.13 | 104.12 | 106.04 | 62.02 | 60.02 | 312.46 |
| 10 | 0 | 56 | 16 | 100 | 106.28 | 104.12 | 106.52 | 528.00 | 425.00 | 316.20 |
| | 25 | 48 | 8 | 100 | 110.38 | 107.63 | 111.21 | 555.87 | 501.20 | 346.20 |
| | 50 | 28 | 4 | 100 | 107.03 | 104.97 | 109.28 | 587.00 | 499.98 | 373.93 |
| 25 | 0 | 24 | 0 | 100 | — | — | — | — | — | — |
| | 25 | 4 | 0 | 100 | — | — | — | — | — | — |
| | 50 | 0 | 0 | 100 | — | — | — | — | — | — |

As becomes apparent, the inventive method according to the disclosure outperformed at the success rate metric. Moreover, the success rate falls rapidly in the C2 method because the agents and static obstacles are treated in the same form, i.e., as a constraint at that specific time step for the quadratic problem. The selection of the final time for the trajectories must be the same for all agents; this increases the chances of failure and the method's dependence on specific scenarios with a limited number of agents. In the case of 25 agents and 50 trees, none of the compared methods solved any scenario. The C1 method uses a finite time horizon to compute trajectories collision-free. When the static obstacles and the agents increase, that time horizon must be different, so the algorithm can anticipate and avoid the collisions.

### Cooperative Stochastic Planning

With reference again to FIGS. 4 and 5, and the operations 426 and 428 of the cooperative stochastic planning method, trajectory generation may be based on the position of other AMRs 102 with respect to the AMR 102.

According to the disclosure, the cooperative stochastic planning method generates a reference trajectory (independently for each variable {x, y, z, ψ}), such that the AMR 102 may navigate from an initial state {x₀(0), . . . , xₙ₋₁(0)} to a final state {x₀(t_{ƒ}), . . . , xₙ₋₁(t_{ƒ})} in a desired time t_{ƒ}, where xᵢ(t) represents i-th derivative of the trajectory. Alternatively, given a set of constraints on x⁽ⁱ⁾(t), an optimization problem may be applied to find the shortest time t_{ƒ} such that all constraints are satisfied.

Advantageously, the planning method advances upon conventional waypoint navigation by selecting the time t_{ƒ} in which the final state is to be reached. This improves navigation in dynamic environments to guarantee collision free navigation. In this example, the final time t_{ƒ} may be selected so that the final time occurs with the planning period T as discussed above with respect to FIG. 5 (e.g. t_{ƒ}=t₀+T).

For a function y(t), y⁽ⁱ⁾(t) represent the i-th derivative of y(t) with respect to time. Let hᵢ(t) and wᵢ(t), i=0, . . . , n, be a (n+1)−times differentiable functions such that

$${h}_{i}^{( j )} ( 0 ) = \{ \begin{matrix}1 & if j = i \\ 0 & otherwise\end{matrix} \\ {w}_{i}^{( j )} ( {t}_{f} ) = \{ \begin{matrix}1 & if j = i \\ 0 & otherwise\end{matrix} \\ and \\ {h}_{i}^{( j )} ( {t}_{f} ) = 0 for all j = 0 , … , n - 1 \\ {w}_{i}^{( j )} ( 0 ) = 0 for all j = 0 , … , n - 1$$

Then, the trajectory:

$$y ( t ) = {\sum }_{i = 0}^{n - 1} ( {w}_{i} ( \frac{t}{{t}_{f}} ) {x}_{i} ( {t}_{f} ) + {h}_{i} ( \frac{t}{{t}_{f}} ) {x}_{i} ( {t}_{0} ) )$$

Satisfies y⁽ⁱ⁾(t₀)=xᵢ(t₀) and y⁽ⁱ⁾(t_{ƒ})=xᵢ(t_{ƒ}), for all i=0, . . . , n−1

### Optimality of Trajectories

Let {hᵢ}ᵢ₌₀ⁿ be a (2n+1)-th order polynomials satisfying the previous conditions. Then, the generated trajectory

$$y ( t ) = {\sum }_{i = 0}^{n - 1} ( {w}_{i} ( \frac{t}{{t}_{f}} ) {x}_{i} ( {t}_{f} ) + {h}_{i} ( \frac{t}{{t}_{f}} ) {x}_{i} ( {t}_{0} ) )$$

is the solution of the optimization problem:

min y⁽ⁿ⁺¹⁾(t),

subject to:

y⁽ⁱ⁾(t₀)=xᵢ(t₀) and y⁽ⁱ⁾(t_{ƒ})=xᵢ(t_{ƒ}), for all i=0, . . . , n−1

A minimum acceleration trajectory with t₀=0 and t_{ƒ}=1 is obtained as:

y(t)=(−t²+t³)x₁(t_{ƒ})+(3t²−2t³)x₀(t_{ƒ})+(1−3t²+2t³)x₀(0)+(t−2t²+t³)x₁(0)

\dot{y}(t)=(−2t+3t²)x₁(t_{ƒ})+(6t−6t²)x₀(t_{ƒ})+(−6t+6t²)x₀(0)+(1−4t+3t²)x₁(0)

ÿ(t)=(−2+6t)x₁(t_{ƒ})+(6−12t)x₀(t_{ƒ})+(−6+12t²)x₀(0)+(−4+6t)x₁(0)

Given a set of constraints:

|\dot{y}|≤vₘₐₓ

|ÿ|≤aₘₐₓ

we can find analytically (for the second-order case) or via an optimization problem (for higher-order case) the minimum t_{ƒ} satisfying the constraints.

The cooperative stochastic planning method according to the disclosure considers initial and final high-order derivatives (velocity, acceleration, jerk), resulting in optimal trajectories so as to advantageously improve upon the conventional trajectory generation methods using polynomials to generate trajectories from an initial resting position to a final resting position.

### EXAMPLES

The following examples pertain to various techniques of the present disclosure.

An example (e.g. example 1) relates to a controller for an autonomous agent, including a memory storing a path planning algorithm; and a processor configured to execute the path planning algorithm to: determine if an active neighboring autonomous agent is present; and based on the presence of the active neighboring autonomous agent, control the autonomous agent to selectively operate: in an independent path planning operation mode; and in a coordinating path planning operation mode.

Another example (e.g. example 2) relates to a previously-described example (e.g. example 1), wherein, in the independent path planning operation mode, the processor is configured to: perform stochastic path planning to determine a path including at least one waypoint; determine a path segment of the determined path within a field-of-view (FOV) of the autonomous agent; and generate a trajectory based on the path segment.

Another example (e.g. example 3) relates to a previously-described example (e.g. one or more of examples 1-2), wherein in the coordinating path planning operation mode, the processor is configured to: generate a roadmap including a plurality of paths traversable by the autonomous agent; select a path of the plurality of paths to determine an initial waypoint within a field-of-view (FOV) of the autonomous agent and reachable within a planning period; and generate a trajectory based on the initial waypoint and a planned trajectory of the neighboring autonomous agent.

Another example (e.g. example 4) relates to a previously-described example (e.g. example 3), wherein the planned trajectory of the neighboring autonomous agent includes a planned initial waypoint of the neighboring autonomous agent, the processor being configured to determine whether the determined initial waypoint and the planned initial waypoint of the neighboring autonomous agent conflict, and to generate the trajectory based on the conflict determination.

Another example (e.g. example 5) relates to a previously-described example (e.g. one or more of examples 3-4), wherein the processor is further configured to provide the generated trajectory to the neighboring autonomous agent.

Another example (e.g. example 6) relates to a previously-described example (e.g. one or more of examples 3-5), wherein the planning period is a maximum time duration until a next planning operation by the controller.

Another example (e.g. example 7) relates to a previously-described example (e.g. one or more of examples 3-6), wherein the initial waypoint is determined such that the initial waypoint is reachable within the planning period with a zero velocity and acceleration.

Another example (e.g. example 8) relates to a previously-described example (e.g. one or more of examples 3-7), wherein determining the initial waypoint within the field-of-view is further based on a communication radius of the autonomous agent.

Another example (e.g. example 9) relates to a previously-described example (e.g. one or more of examples 3-8), wherein the generation of the roadmap, selection of the path, and the generation of the trajectory is iteratively performed until a goal waypoint is reached.

Another example (e.g. example 10) relates to a previously-described example (e.g. one or more of examples 3-9), wherein each of the paths include at least one waypoint within the FOV of the autonomous agent.

Another example (e.g. example 11) relates to a previously-described example (e.g. one or more of examples 1-2), wherein, in the coordinating path planning operation mode, the processor is configured to: generate a trajectory based on a determined path including at least one waypoint; and adapt the trajectory based on a distance between the autonomous agent and the neighboring autonomous agent.

Another example (e.g. example 12) relates to a previously-described example (e.g. example 11), wherein the trajectory is adapted based further on a comparison of a priority value of the autonomous agent and a priority value of the neighboring autonomous agent.

Another example (e.g. example 13) relates to a previously-described example (e.g. one or more of examples 11-12), wherein a velocity of the autonomous agent is proportional to the distance to neighboring autonomous agent.

Another example (e.g. example 14) relates to a non-transitory computer-readable storage medium with an executable program stored thereon, that when executed, instructs a processor to perform a motion planning method, for an autonomous agent, comprising: determining if an active neighboring autonomous agent is present; and based on the presence of the active neighboring autonomous agent, controlling the autonomous agent to selectively operate: in an independent path planning operation mode; and in a coordinating path planning operation mode.

Another example (e.g. example 15) relates to a previously-described example (e.g. example 14), wherein the independent path planning operation mode comprises: performing stochastic path planning to determine a path including at least one waypoint; determining a path segment of the determined path within a field-of-view (FOV) of the autonomous agent; and generating a trajectory based on the path segment.

Another example (e.g. example 16) relates to a previously-described example (e.g. one or more of examples 14-15), wherein the coordinating path planning operation mode comprises: generating a roadmap including a plurality of paths traversable by the autonomous agent; selecting a path of the plurality of paths to determine an initial waypoint within a field-of-view (FOV) of the autonomous agent and reachable within a planning period; and generating a trajectory based on the initial waypoint and a planned trajectory of the neighboring autonomous agent.

Another example (e.g. example 17) relates to a previously-described example (e.g. example 16), further comprising providing the generated trajectory to the neighboring autonomous agent.

Another example (e.g. example 18) relates to a previously-described example (e.g. one or more of examples 16-17), wherein the planning period is a maximum time duration until a next planning operation, the initial waypoint being determined such that the initial waypoint is reachable within the planning period with a zero velocity and acceleration.

Another example (e.g. example 19) relates to a previously-described example (e.g. one or more of examples 16-18), wherein determining the initial waypoint within the field-of-view is further based on a communication radius of the autonomous agent.

Another example (e.g. example 20) relates to a previously-described example (e.g. one or more of examples 16-19), wherein the generation of the roadmap, selection of the path, and the generation of the trajectory is iteratively performed until a goal waypoint is reached.

Another example (e.g. example 21) relates to a previously-described example (e.g. example 14), wherein the coordinating path planning operation mode comprises:

generating a trajectory based on a determined path including at least one waypoint; and

adapting the trajectory based on a distance between the autonomous agent and the neighboring autonomous agent.

Another example (e.g. example 22) relates to a previously-described example (e.g. example 21), wherein the trajectory is adapted based further on a comparison of a priority value of the autonomous agent and a priority value of the neighboring autonomous agent.

Another example (e.g. example 23) relates to a previously-described example (e.g. one or more of examples 21-22), wherein a velocity of the autonomous agent is proportional to the distance to neighboring autonomous agent.

Another example (e.g. example 24) relates to an autonomous agent, including a sensor configured to analyze an environment of the autonomous agent; and a controller configured to: determine if an active neighboring autonomous agent is present; and based on the presence of the active neighboring autonomous agent, control the autonomous agent to selectively operate: in an independent path planning operation mode; and in a coordinating path planning operation mode.

Another example (e.g. example 25) relates to a previously-described example (e.g. example 24), wherein: in the coordinating path planning operation mode, the controller is configured to: generate a roadmap including a plurality of paths traversable by the autonomous agent; select a path of the plurality of paths to determine an initial waypoint within a field-of-view (FOV) of the autonomous agent and reachable within a planning period; and generate a trajectory based on the initial waypoint and a planned trajectory of the neighboring autonomous agent; or in the coordinating path planning operation mode, the controller is configured to: generate a trajectory based on a determined path including at least one waypoint; and adapt the trajectory based on: a distance between the autonomous agent and the neighboring autonomous agent, and a comparison of a priority value of the autonomous agent and a priority value of the neighboring autonomous agent.

An example (e.g. example 26) relates to a controller for an autonomous agent, including a memory storage means for storing a path planning algorithm; and processing means for executing the path planning algorithm to: determine if an active neighboring autonomous agent is present; and based on the presence of the active neighboring autonomous agent, control the autonomous agent to selectively operate: in an independent path planning operation mode; and in a coordinating path planning operation mode.

Another example (e.g. example 27) relates to a previously-described example (e.g. example 26), wherein, in the independent path planning operation mode, the processing means is for: performing stochastic path planning to determine a path including at least one waypoint; determining a path segment of the determined path within a field-of-view (FOV) of the autonomous agent; and generate a trajectory based on the path segment.

Another example (e.g. example 28) relates to a previously-described example (e.g. one or more of examples 26-27), wherein in the coordinating path planning operation mode, the processing means is for: generating a roadmap including a plurality of paths traversable by the autonomous agent; selecting a path of the plurality of paths to determine an initial waypoint within a field-of-view (FOV) of the autonomous agent and reachable within a planning period; and generating a trajectory based on the initial waypoint and a planned trajectory of the neighboring autonomous agent.

Another example (e.g. example 29) relates to a previously-described example (e.g. example 28), wherein the planned trajectory of the neighboring autonomous agent includes a planned initial waypoint of the neighboring autonomous agent, the processing means is for determining whether the determined initial waypoint and the planned initial waypoint of the neighboring autonomous agent conflict, and for generating the trajectory based on the conflict determination.

Another example (e.g. example 30) relates to a previously-described example (e.g. one or more of examples 28-29), wherein the processing means is further for providing the generated trajectory to the neighboring autonomous agent.

Another example (e.g. example 31) relates to a previously-described example (e.g. one or more of examples 28-30), wherein the planning period is a maximum time duration until a next planning operation by the controller.

Another example (e.g. example 32) relates to a previously-described example (e.g. one or more of examples 28-31), wherein the initial waypoint is determined such that the initial waypoint is reachable within the planning period with a zero velocity and acceleration.

Another example (e.g. example 33) relates to a previously-described example (e.g. one or more of examples 28-32), wherein determining the initial waypoint within the field-of-view is further based on a communication radius of the autonomous agent.

Another example (e.g. example 34) relates to a previously-described example (e.g. one or more of examples 28-33), wherein the generation of the roadmap, selection of the path, and the generation of the trajectory is iteratively performed until a goal waypoint is reached.

Another example (e.g. example 35) relates to a previously-described example (e.g. one or more of examples 28-34), wherein each of the paths include at least one waypoint within the FOV of the autonomous agent.

Another example (e.g. example 36) relates to a previously-described example (e.g. one or more of examples 26-27), wherein, in the coordinating path planning operation mode, the processing means is for: generating a trajectory based on a determined path including at least one waypoint; and adapting the trajectory based on a distance between the autonomous agent and the neighboring autonomous agent.

Another example (e.g. example 37) relates to a previously-described example (e.g. example 36), wherein the trajectory is adapted based further on a comparison of a priority value of the autonomous agent and a priority value of the neighboring autonomous agent.

Another example (e.g. example 38) relates to a previously-described example (e.g. one or more of examples 36-37), wherein a velocity of the autonomous agent is proportional to the distance to neighboring autonomous agent.

Another example (e.g. example 39) relates to an autonomous agent, including sensing means for analyzing an environment of the autonomous agent; and controlling means for: determining if an active neighboring autonomous agent is present; and based on the presence of the active neighboring autonomous agent, controlling the autonomous agent to selectively operate: in an independent path planning operation mode; and in a coordinating path planning operation mode.

Another example (e.g. example 40) relates to a previously-described example (e.g. example 24), wherein: in the coordinating path planning operation mode, the controlling means is for: generating a roadmap including a plurality of paths traversable by the autonomous agent; selecting a path of the plurality of paths to determine an initial waypoint within a field-of-view (FOV) of the autonomous agent and reachable within a planning period; and generating a trajectory based on the initial waypoint and a planned trajectory of the neighboring autonomous agent; or in the coordinating path planning operation mode, the controlling means is for: generating a trajectory based on a determined path including at least one waypoint; and adapting the trajectory based on: a distance between the autonomous agent and the neighboring autonomous agent, and a comparison of a priority value of the autonomous agent and a priority value of the neighboring autonomous agent.

Another example (e.g. example 41) relates to an autonomous agent comprising the controller of a previously-described example (e.g. one or more of examples 1-13 and 26-38).

Another example (e.g. example 42) relates to a previously-described example (e.g. one or more of examples 1-41), wherein the autonomous agent is an autonomous mobile robot.

Another example (e.g. example 43) relates to non-transitory computer-readable storage medium with an executable program stored thereon, that when executed, instructs a processor to perform a method as shown and described.

Another example (e.g. example 44) relates to an autonomous agent as shown and described.

Another example (e.g. example 45) relates to an apparatus as shown and described.

Another example (e.g. example 56) relates a method as shown and described.

### CONCLUSION

The aforementioned description will so fully reveal the general nature of the implementation of the disclosure that others can, by applying knowledge within the skill of the art, readily modify and/or adapt for various applications such specific implementations without undue experimentation and without departing from the general concept of the present disclosure. Therefore, such adaptations and modifications are intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Each implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

The exemplary implementations described herein are provided for illustrative purposes, and are not limiting. Other implementations are possible, and modifications may be made to the exemplary implementations. Therefore, the specification is not meant to limit the disclosure. Rather, the scope of the disclosure is defined only in accordance with the following claims and their equivalents.

The designs of the disclosure may be implemented in hardware (e.g., circuits), firmware, software, or any combination thereof. Designs may also be implemented as instructions stored on a machine-readable medium, which may be read and executed by one or more processors. A machine-readable medium may include any mechanism for storing or transmitting information in a form readable by a machine (e.g., a computing device). A machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general-purpose computer.

Throughout the drawings, it should be noted that like reference numbers are used to depict the same or similar elements, features, and structures, unless otherwise noted.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. The terms “group (of)”, “set (of)”, “collection (of)”, “series (of)”, “sequence (of)”, “grouping (of)”, etc., and the like in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The phrase “at least one of” with regard to a group of elements may be used herein to mean at least one element from the group consisting of the elements. The phrase “at least one of” with regard to a group of elements may be used herein to mean a selection of: one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned data types and may take various forms and represent any information as understood in the art.

The terms “processor,” “processing circuitry,” or “controller” as used herein may be understood as any kind of technological entity that allows handling of data. The data may be handled according to one or more specific functions executed by the processor, processing circuitry, or controller. Further, processing circuitry, a processor, or a controller as used herein may be understood as any kind of circuit, e.g., any kind of analog or digital circuit. Processing circuitry, a processor, or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as processing circuitry, a processor, controller, or logic circuit. It is understood that any two (or more) of the processors, controllers, logic circuits, or processing circuitries detailed herein may be realized as a single entity with equivalent functionality or the like, and conversely that any single processor, controller, logic circuit, or processing circuitry detailed herein may be realized as two (or more) separate entities with equivalent functionality or the like.

As used herein, “memory” is understood as a computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” refers to any type of executable instruction, including firmware.

In one or more of the implementations described herein, processing circuitry can include memory that stores data and/or instructions. The memory can be any well-known volatile and/or non-volatile memory, including read-only memory (ROM), random access memory (RAM), flash memory, a magnetic storage media, an optical disc, erasable programmable read only memory (EPROM), and programmable read only memory (PROM). The memory can be non-removable, removable, or a combination of both.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). Processing circuitry, a processor, or a controller may transmit or receive data over a software-level connection with another processor, controller, or processing circuitry in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

An “agent” may be understood to include any type of driven object. An agent may be a driven object with a combustion engine, a reaction engine, an electrically driven object, a hybrid driven object, or a combination thereof. An agent may be or may include a moving robot, a personal transporter, a drone, and the like.

The term “autonomous agent” may describe an agent that implements all or substantially all navigational changes, at least during some (significant) part (spatial or temporal, e.g., in certain areas, or when ambient conditions are fair, or on highways, or above or below a certain speed) of some drives. Sometimes an “autonomous agent” is distinguished from a “partially autonomous agent” or a “semi-autonomous agent” to indicate that the agent is capable of implementing some (but not all) navigational changes, possibly at certain times, under certain conditions, or in certain areas. A navigational change may describe or include a change in one or more of steering, braking, or acceleration/deceleration of the agent. An agent may be described as autonomous even in case the agent is not fully automatic (fully operational with driver or without driver input). Autonomous agents may include those agents that can operate under driver control during certain time periods and without driver control during other time periods. Autonomous agents may also include agents that control only some implementations of agent navigation, such as steering (e.g., to maintain an agent course between agent lane constraints) or some steering operations under certain circumstances (but not under all circumstances), but may leave other implementations of agent navigation to the driver (e.g., braking or braking under certain circumstances). Autonomous agents may also include agents that share the control of one or more implementations of agent navigation under certain circumstances (e.g., hands-on, such as responsive to a driver input) and agents that control one or more implementations of agent navigation under certain circumstances (e.g., hands-off, such as independent of driver input). Autonomous agents may also include agents that control one or more implementations of agent navigation under certain circumstances, such as under certain environmental conditions (e.g., spatial areas, roadway conditions). In some implementations, autonomous agents may handle some or all implementations of braking, speed control, velocity control, and/or steering of the agent. An autonomous agent may include those agents that can operate without a driver. The level of autonomy of an agent may be described or determined by the Society of Automotive Engineers (SAE) level of the agent (as defined by the SAE in SAE J3016 2018: Taxonomy and definitions for terms related to driving automation systems for on road motor vehicles) or by other relevant professional organizations. The SAE level may have a value ranging from a minimum level, e.g. level 0 (illustratively, substantially no driving automation), to a maximum level, e.g. level 5 (illustratively, full driving automation).

The systems and methods of the disclosure may utilize one or more machine learning models to perform corresponding functions of the agent (or other functions described herein). The term “model” as, for example, used herein may be understood as any kind of algorithm, which provides output data from input data (e.g., any kind of algorithm generating or calculating output data from input data). A machine learning model may be executed by a computing system to progressively improve performance of a specific task. According to the disclosure, parameters of a machine learning model may be adjusted during a training phase based on training data. A trained machine learning model may then be used during an inference phase to make predictions or decisions based on input data.

The machine learning models described herein may take any suitable form or utilize any suitable techniques. For example, any of the machine learning models may utilize supervised learning, semi-supervised learning, unsupervised learning, or reinforcement learning techniques.

In supervised learning, the model may be built using a training set of data that contains both the inputs and corresponding desired outputs. Each training instance may include one or more inputs and a desired output. Training may include iterating through training instances and using an objective function to teach the model to predict the output for new inputs. In semi-supervised learning, a portion of the inputs in the training set may be missing the desired outputs.

In unsupervised learning, the model may be built from a set of data which contains only inputs and no desired outputs. The unsupervised model may be used to find structure in the data (e.g., grouping or clustering of data points) by discovering patterns in the data. Techniques that may be implemented in an unsupervised learning model include, e.g., self-organizing maps, nearest-neighbor mapping, k-means clustering, and singular value decomposition.

Reinforcement learning models may be given positive or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

The systems and methods of the disclosure may utilize one or more classification models. In a classification model, the outputs may be restricted to a limited set of values (e.g., one or more classes). The classification model may output a class for an input set of one or more input values. An input set may include road condition data, event data, sensor data, such as image data, radar data, LIDAR data and the like, and/or other data as would be understood by one of ordinary skill in the art. A classification model as described herein may, for example, classify certain driving conditions and/or environmental conditions, such as weather conditions, road conditions, and the like. References herein to classification models may contemplate a model that implements, e.g., any one or more of the following techniques: linear classifiers (e.g., logistic regression or naive Bayes classifier), support vector machines, decision trees, boosted trees, random forest, neural networks, or nearest neighbor.

One or more regression models may be used. A regression model may output a numerical value from a continuous range based on an input set of one or more values. References herein to regression models may contemplate a model that implements, e.g., any one or more of the following techniques (or other suitable techniques): linear regression, decision trees, random forest, or neural networks.

A machine learning model described herein may be or may include a neural network. The neural network may be any kind of neural network, such as a convolutional neural network, an autoencoder network, a variational autoencoder network, a sparse autoencoder network, a recurrent neural network, a deconvolutional network, a generative adversarial network, a forward-thinking neural network, a sum-product neural network, and the like. The neural network may include any number of layers. The training of the neural network (e.g., adapting the layers of the neural network) may use or may be based on any kind of training principle, such as backpropagation (e.g., using the backpropagation algorithm).

As described herein, the following terms may be used as synonyms: driving parameter set, driving model parameter set, safety layer parameter set, driver assistance, automated driving model parameter set, and/or the like (e.g., driving safety parameter set). These terms may correspond to groups of values used to implement one or more models for directing an agent to operate according to the manners described herein. Furthermore, throughout the present disclosure, the following terms may be used as synonyms: driving parameter, driving model parameter, safety layer parameter, driver assistance and/or automated driving model parameter, and/or the like (e.g., driving safety parameter), and may correspond to specific values within the previously described sets.

1. A controller for an autonomous agent, comprising:
memory storing a path planning algorithm; and
a processor configured to execute the path planning algorithm to:
determine if an active neighboring autonomous agent is present; and
based on the presence of the active neighboring autonomous agent, control the autonomous agent to selectively operate:
in an independent path planning operation mode; and
in a coordinating path planning operation mode.

2. The controller of claim 1, wherein, in the independent path planning operation mode, the processor is configured to:
perform stochastic path planning to determine a path including at least one waypoint;
determine a path segment of the determined path within a field-of-view (FOV) of the autonomous agent; and
generate a trajectory based on the path segment.

3. The controller of claim 1, wherein, in the coordinating path planning operation mode, the processor is configured to:
generate a roadmap including a plurality of paths traversable by the autonomous agent;
select a path of the plurality of paths to determine an initial waypoint within a field-of-view (FOV) of the autonomous agent and reachable within a planning period; and
generate a trajectory based on the initial waypoint and a planned trajectory of the neighboring autonomous agent.

4. The controller of claim 3, wherein the planned trajectory of the neighboring autonomous agent includes a planned initial waypoint of the neighboring autonomous agent, the processor being configured to determine whether the determined initial waypoint and the planned initial waypoint of the neighboring autonomous agent conflict, and to generate the trajectory based on the conflict determination.

5. The controller of claim 3, wherein the processor is further configured to provide the generated trajectory to the neighboring autonomous agent.

6. The controller of claim 3, wherein the planning period is a maximum time duration until a next planning operation by the controller.

7. The controller of claim 3, wherein the initial waypoint is determined such that the initial waypoint is reachable within the planning period with a zero velocity and acceleration.

8. The controller of claim 3, wherein determining the initial waypoint within the field-of-view is further based on a communication radius of the autonomous agent.

9. The controller of claim 3, wherein the generation of the roadmap, selection of the path, and the generation of the trajectory is iteratively performed until a goal waypoint is reached.

10. The controller of claim 3, wherein each of the paths include at least one waypoint within the FOV of the autonomous agent.

11. The controller of claim 1, wherein, in the coordinating path planning operation mode, the processor is configured to:
generate a trajectory based on a determined path including at least one waypoint; and
adapt the trajectory based on a distance between the autonomous agent and the neighboring autonomous agent.

12. The controller of claim 11, wherein the trajectory is adapted based further on a comparison of a priority value of the autonomous agent and a priority value of the neighboring autonomous agent.

13. The controller of claim 11, wherein a velocity of the autonomous agent is proportional to the distance to neighboring autonomous agent.

14. A non-transitory computer-readable storage medium with an executable program stored thereon, that when executed, instructs a processor to perform a motion planning method, for an autonomous agent, comprising:
determining if an active neighboring autonomous agent is present; and
based on the presence of the active neighboring autonomous agent, controlling the autonomous agent to selectively operate:
in an independent path planning operation mode; and
in a coordinating path planning operation mode.

15. The storage medium of claim 14, wherein the independent path planning operation mode comprises:
performing stochastic path planning to determine a path including at least one waypoint;
determining a path segment of the determined path within a field-of-view (FOV) of the autonomous agent; and
generating a trajectory based on the path segment.

16. The storage medium of claim 14, wherein the coordinating path planning operation mode comprises:
generating a roadmap including a plurality of paths traversable by the autonomous agent;
selecting a path of the plurality of paths to determine an initial waypoint within a field-of-view (FOV) of the autonomous agent and reachable within a planning period; and
generating a trajectory based on the initial waypoint and a planned trajectory of the neighboring autonomous agent.

17. The storage medium of claim 16, further comprising providing the generated trajectory to the neighboring autonomous agent.

18. The storage medium of claim 16, wherein the planning period is a maximum time duration until a next planning operation, the initial waypoint being determined such that the initial waypoint is reachable within the planning period with a zero velocity and acceleration.

19. The storage medium of claim 16, wherein determining the initial waypoint within the field-of-view is further based on a communication radius of the autonomous agent.

20. The storage medium of claim 16, wherein the generation of the roadmap, selection of the path, and the generation of the trajectory is iteratively performed until a goal waypoint is reached.

21. The storage medium of claim 14, wherein the coordinating path planning operation mode comprises:
generating a trajectory based on a determined path including at least one waypoint; and
adapting the trajectory based on a distance between the autonomous agent and the neighboring autonomous agent.

22. The storage medium of claim 21, wherein the trajectory is adapted based further on a comparison of a priority value of the autonomous agent and a priority value of the neighboring autonomous agent.

23. The storage medium of claim 21, wherein a velocity of the autonomous agent is proportional to the distance to neighboring autonomous agent.

24. An autonomous agent, comprising:
a sensor configured to analyze an environment of the autonomous agent; and
a controller configured to:
determine if an active neighboring autonomous agent is present; and
based on the presence of the active neighboring autonomous agent, control the autonomous agent to selectively operate:
in an independent path planning operation mode; and
in a coordinating path planning operation mode.

25. The autonomous agent of claim 24, wherein:
in the coordinating path planning operation mode, the controller is configured to:
generate a roadmap including a plurality of paths traversable by the autonomous agent;
select a path of the plurality of paths to determine an initial waypoint within a field-of-view (FOV) of the autonomous agent and reachable within a planning period; and
generate a trajectory based on the initial waypoint and a planned trajectory of the neighboring autonomous agent; or
in the coordinating path planning operation mode, the controller is configured to:
generate a trajectory based on a determined path including at least one waypoint; and
adapt the trajectory based on: a distance between the autonomous agent and the neighboring autonomous agent, and a comparison of a priority value of the autonomous agent and a priority value of the neighboring autonomous agent.
